(19) United States
(12) Patent Application Publication
(10) Pub. No.: US 2004/0006446 A1
(43) Pub. Date: Jan. 8, 2004

(54) Prime number generation

(76) Inventor: Fred Andreas Schermer, San Francisco, CA (US)

Correspondence Address: F. A. SCHERMER, 139 - 29th STREET, SAN FRANCISCO, CA, 94110, US

(21) Appl. No.: 10/115,367

(22) Filed: Jul. 8, 2002

(51) Int. Cl. G06F 101/14

(52) U.S. Cl. 702/179

(57) ABSTRACT

This formula generates all prime numbers 5 and higher up to any chosen number. The distinction between this prime number formula and any previously known methods is that this formula uses calculations to deliver the positions of the prime numbers rather than determining whether each and every number is a prime number or is not a prime number. With not having to calculate each and every number, this formula therefore delivers a method that is faster than any known method to find all desired prime numbers. Whether 1, 2 and 3 turn out to be prime numbers or not is a matter of definition. Current definition forces me to claim that this method, up to the chosen number, finds all prime numbers 5 and higher.

This formula can help anybody find the prime numbers, 5 and higher, all the way up to any chosen number. The prime numbers are not found based on calculating whether a number is or is not a prime number; it is determined on the position whether a number is a prime number or not. All positions of prime numbers 5 and up are linked, and this formula describes/makes use of that linkage. After choosing a computer program that is capable of working with numbers, fill in the formula as the core of your program. There is one open space. That is the place where the user has to fill in any chosen number.

After filling in a number the program will run and deliver all prime numbers from 5 up to the last prime number until reaching this chosen number. It is faster than any currently used method.

What I claim as my invention is:

1. a methodical formula that finds all prime numbers, 5 and up, until any chosen number, based on the link that exists between the positions of these prime numbers, not on the actual value of these or any other numbers.
